(19) United States
(12) Patent Application Publication
(10) Pub. No.: US 2011/0202774 A1
(43) Pub. Date: Aug. 18, 2011

(54) System for Collection and Longitudinal Analysis of Anonymous Student Data

(76) Inventor: Charles Henry Kratsch, Ham Lake, MN (US)

(21) Appl. No.: 12/705,863

(22) Filed: Feb. 15, 2010

(51) Int. Cl. G06F 12/14; G06F 17/30; H04L 9/28

(52) U.S. Cl. 713/189; 380/28; 707/802; 707/E17.044

(57) ABSTRACT

A method and system for aggregating and anonymizing student data is disclosed. A method includes receiving from an educational institution a set of student data records, each student data record associated with a student and including a unique identifier, and lacking information rendering the record personally identifying of a student. The method further includes, for each student data record, extracting the unique identifier associated with the student data record, and encrypting the unique identifier. The method also includes associating the encrypted unique identifier with the student data record to form an anonymized student data record and storing the anonymized student data record in a database containing aggregated student data.

### TECHNICAL FIELD

The present application relates generally to collection and organization of data records. In particular, the present application relates to a system for collection and analysis of anonymous student data.

### BACKGROUND

Learning institutions, including elementary schools, middle schools, high schools, and secondary education institutions (colleges and universities) store a large amount of information about each student attending that institution. The storage of information typically occurs on an institutional level, e.g., for a group of commonly-managed institutions (e.g., elementary school(s), middle school(s), and high school(s)). This information can include student records, including attendance, grades, biographical and demographic information, and other information gathered by the institution.

Information about a particular student can be difficult to gather in a cohesive location for a number of reasons. For example, the student may move and switch schools or otherwise transfer to a different school otherwise unaffiliated with their previous school. The student's new school may request record information from the student's former school, but that information may be incomplete or incompatible with the filing or storage systems at the new school. Additionally, those school records may only include partial information due to record loss or degradation, and typically are updated/consolidated only upon request.

Additionally, existing collections of student records reside within the control of the institution or district at which the student is enrolled. As such, that institution/district can determine trends and information among their students, but larger trends and analysis cannot be detected by a single institution or district.

Data sharing with individuals or entities external to an institution or district, or across multiple institutions, could provide the ability to determine larger trends in education. However, such data sharing is difficult due to confidentiality concerns and restrictions set by statute. For example, the Family Educational Rights and Privacy Act (FERPA) restricts the type of data that can be shared externally from an educational department or institution, requiring that the information not be able to personally identify an individual student. In existing systems, such information is typically manually extracted when data is shared. This requires substantial time and effort, and causes a substantial barrier to information sharing.

For these and other reasons, improvements are desirable.

### SUMMARY

In accordance with the following disclosure, the above and other problems are addressed by the following:

In a first aspect, a method for aggregating and anonymizing student data is disclosed. The method includes receiving from an educational institution a set of student data records, each student data record associated with a student and including a unique identifier, and lacking information rendering the record personally identifying of a student. The method further includes, for each student data record, extracting the unique identifier associated with the student data record, and encrypting the unique identifier. The method also includes associating the encrypted unique identifier with the student data record to form an anonymized student data record and storing the anonymized student data record in a database containing aggregated student data.

In a second aspect, a system for aggregating and anonymizing student data is disclosed. The system includes a database configured and arranged to store aggregated student data, and a computing system external to educational institutions and communicatively connected to the database. The computing system is configured to receive a set of student data records from each of a plurality of educational institutions, each student data record associated with a student and including a unique identifier, and lacking information rendering the record personally identifying of a student. The computing system is configured to process each student data record in each set of student data records. For each student data record, the computing system is configured to extract the unique identifier associated with the student data record and encrypt the unique identifier. The computing system is also configured to associate the encrypted unique identifier with the student data record to form an anonymized student data record and store the anonymized student data record in the database.

In a third aspect, a system for aggregating and anonymizing student data is disclosed. The system includes a plurality of computing systems residing at a corresponding plurality of educational institutions and configured to manage student data for the corresponding educational institutions, as well as a central database configured and arranged to store aggregated student data. The system also includes a central computing system external to educational institutions and communicatively connected to the central database and to each of the plurality of computing systems. The central computing system is configured to receive a set of student data records from each of the plurality of computing systems, each student data record associated with a student and including a unique identifier, and lacking information rendering the record personally identifying of a student. The central computing system is configured to process each student data record in each set of student data records. For each student data record, the central computing system is configured to extract the unique identifier associated with the student data record and apply a hash algorithm to the unique identifier. The central computing system is further configured to associate the hashed unique identifier with the student data record to form an anonymized student data record, and store the anonymized student data record in the central database.

### BRIEF DESCRIPTION OF THE DRAWINGS

FIG. 1 is an example network in which aspects of the present disclosure can be implemented;

FIG. 2 illustrates an example electronic computing device capable of implementing aspects of the present disclosure;

FIG. 3 illustrates a logical data flow for collection and longitudinal analysis of anonymous student data, according to a possible embodiment of the present disclosure;

FIG. 4A illustrates an example student record according to a possible embodiment of the present disclosure;

FIG. 4B illustrates the example student record of FIG. 4A after redaction of personally-identifying information, according to a possible embodiment of the present disclosure;

FIG. 4C illustrates the example student record of FIG. 4B after anonymization, according to a possible embodiment of the present disclosure;

FIG. 5 is a flowchart of methods and systems for collection and longitudinal analysis of anonymous student data, according to a possible embodiment of the present disclosure;

FIG. 6 is a flowchart of methods and systems for exporting student data from an educational institution or entity, according to a possible embodiment of the present disclosure;

FIG. 7 is a flowchart of methods and systems for extracting student data from an educational institution or entity, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to compilation and anonymization of student data. By compiling anonymous student data using the methods and systems of the present disclosure, a complete set of student data can be collected, and robust reports can be generated to discover trends over the entire academic career of a student or group of students, or to determine the efficacy of a particular educational program in a particular geographical region, or other trend information. These reports extend across multiple institutions due to the protections provided by the anonymization of records to protect student confidentiality.

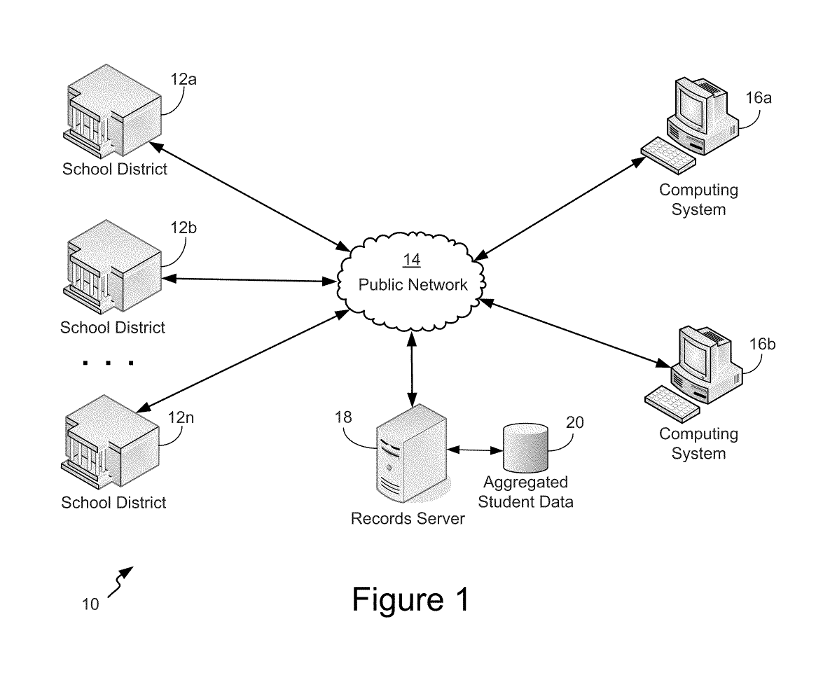

Referring now to FIG. 1, an example network 10 is shown in which aspects of the present disclosure can be implemented. The network 10 can, in certain embodiments, embody a system for aggregating and anonymizing student data. In the embodiment shown, the network 10 includes a plurality of school districts 12a-n connected via a public network 14. The public network also connects to a number of computing systems (illustrated as computing systems 16a-b) and a records server 18. Each of these systems is described below.

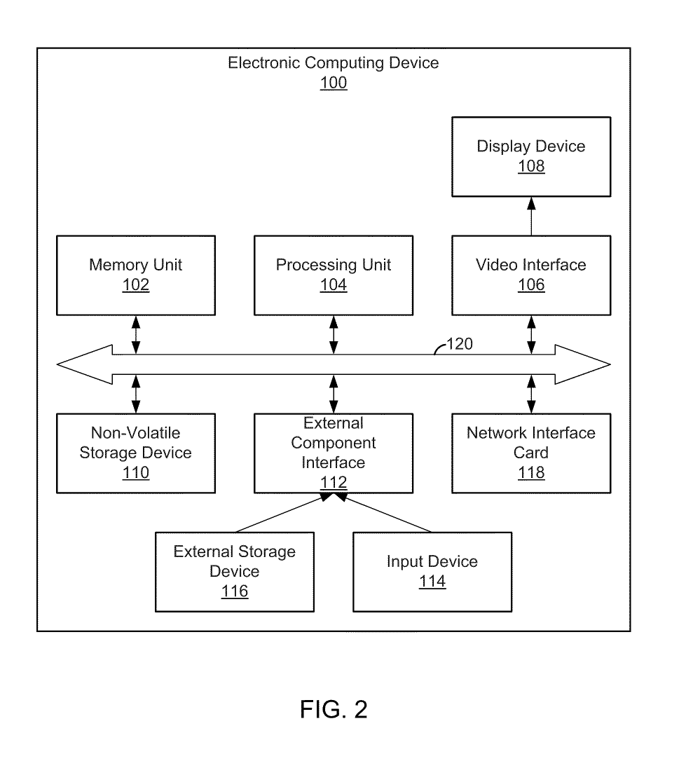

The school districts 12a-n each represent an educational institution or group of institutions capable of sharing data internally but lacking rights to share all student data externally (e.g., with researchers or other entities). Therefore, the school districts 12a-n can correspond to, for example, a school district or board of education, or post-secondary education institution. The public network 14 represents a generally accessible network available to external computing systems, such as computing systems 106a-b. In one example, the public network 14 can include the Internet, as well as any of a number of LAN, WAN, or other area networks. The computing systems 16a-b can be any of a number of types of computing systems, and can include one or more such systems. An example general purpose computing system is described in connection with FIG. 2, below.

The records server 18 is located external to the school districts 12a-n, and can be communicatively connected to or can host a database 20. The database 20 receives and stores aggregated student records received from the school districts 12a-n on a one-time or periodic basis, as set forth in further detail below. The records server 18 is accessible to both computing systems within the school districts 12a-n and computing system 16a-b, allowing individuals both within a school district and external to a school district to view records associated with particular students or groups of students.

The records server 18 is configured to process student records received from the school districts 12a-n to normalize the records (i.e., place each record into a common record format) and optionally to remove any lingering demographic information that may be able to be used to personally identify a student. For example, typically a school district will remove some information from a student data record, such as the student's name, address, and social security number, and any other information useable by the general public to determine the identity of the individual student associated with the record.

The records server 18 is further configured to anonymize each of the student data records prior to storage in the database 20. In certain embodiments, the records server 18 is configured to process each student record to remove an identifier associated with that record with an encrypted (e.g., hashed) identifier, thereby disassociating the record from a record held by the school district from which the record is held. Examples of such processes are described below in connection with FIGS. 2-8.

In certain embodiments, the records server 18 is configured to generate reports upon request of an individual user. Such reports can take any of a number of forms. For example, reports can be generated from a portion of the data in database 20 to illustrate variances or trends in test results in response to a particular curriculum at a number of institutions (e.g., to show efficacy across institutions). Reports about a single student can be generated as well, and can be linked across any of a number of different institutions that student may attend.

The database 20 can be any of a number of types of databases, and can include one or more different databases of varying types. For example, the database 20 can include a transactional database, but can also include a relational or multidimensional database useable to generate reports therefrom. In one example, the database is a SQL Server relational database, managed using SQL Server Database Management System software provided by Microsoft Corporation of Redmond, Wash. Other database types can be used as well.

FIG. 2 is a block diagram illustrating example physical components of an electronic computing device 100, which can be used as any of the entities or computing systems described above in FIG. 1. A computing device, such as electronic computing device 100, typically includes at least some form of computer-readable media. Computer readable media can be any available media that can be accessed by the electronic computing device 100. By way of example, and not limitation, computer-readable media might comprise computer storage media and communication media.

As illustrated in the example of FIG. 2, electronic computing device 100 comprises a memory unit 102. Memory unit 102 is a computer-readable data storage medium capable of storing data and/or instructions. Memory unit 102 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 100 comprises a processing unit 104. As mentioned above, a processing unit is a set of one or more physical electronic integrated circuits that are capable of executing instructions. In a first example, processing unit 104 may execute software instructions that cause electronic computing device 100 to provide specific functionality. In this first example, processing unit 104 may be implemented as one or more processing cores and/or as one or more separate microprocessors. For instance, in this first example, processing unit 104 may be implemented as one or more Intel Core 2 microprocessors. Processing unit 104 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 104 may be implemented as an ASIC that provides specific functionality. In a third example, processing unit 104 may provide specific functionality by using an ASIC and by executing software instructions.

Electronic computing device 100 also comprises a video interface 106. Video interface 106 enables electronic computing device 100 to output video information to a display device 108. Display device 108 may be a variety of different types of display devices. For instance, display device 108 may be a cathode-ray tube display, an LCD display panel, a plasma screen display panel, a touch-sensitive display panel, a LED array, or another type of display device.

In addition, electronic computing device 100 includes a non-volatile storage device 110. Non-volatile storage device 110 is a computer-readable data storage medium that is capable of storing data and/or instructions. Non-volatile storage device 110 may be a variety of different types of non-volatile storage devices. For example, non-volatile storage device 110 may be one or more hard disk drives, magnetic tape drives, CD-ROM drives, DVD-ROM drives, Blu-Ray disc drives, or other types of non-volatile storage devices.

Electronic computing device 100 also includes an external component interface 112 that enables electronic computing device 100 to communicate with external components. As illustrated in the example of FIG. 2, external component interface 112 enables electronic computing device 100 to communicate with an input device 114 and an external storage device 116. In one implementation of electronic computing device 100, external component interface 112 is a Universal Serial Bus (USB) interface. In other implementations of electronic computing device 100, electronic computing device 100 may include another type of interface that enables electronic computing device 100 to communicate with input devices and/or output devices. For instance, electronic computing device 100 may include a PS/2 interface. Input device 114 may be a variety of different types of devices including, but not limited to, keyboards, mice, trackballs, stylus input devices, touch pads, touch-sensitive display screens, or other types of input devices. External storage device 116 may be a variety of different types of computer-readable data storage media including magnetic tape, flash memory modules, magnetic disk drives, optical disc drives, and other computer-readable data storage media.

In the context of the electronic computing device 100, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 102, non-volatile storage device 110, or external storage device 116, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 100.

In addition, electronic computing device 100 includes a network interface card 118 that enables electronic computing device 100 to send data to and receive data from an electronic communication network. Network interface card 118 may be a variety of different types of network interface. For example, network interface card 118 may be an Ethernet interface, a token-ring network interface, a fiber optic network interface, a wireless network interface (e.g., WiFi, WiMax, etc.), or another type of network interface.

Electronic computing device 100 also includes a communications medium 120. Communications medium 120 facilitates communication among the various components of electronic computing device 100. Communications medium 120 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 120, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 100 includes several computer-readable data storage media (i.e., memory unit 102, non-volatile storage device 110, and external storage device 116). Together, these computer-readable storage media may constitute a single data storage system. As discussed above, a data storage system is a set of one or more computer-readable data storage mediums. This data storage system may store instructions executable by processing unit 104. Activities described in the above description may result from the execution of the instructions stored on this data storage system. Thus, when this description says that a particular logical module performs a particular activity, such a statement may be interpreted to mean that instructions of the logical module, when executed by processing unit 104, cause electronic computing device 100 to perform the activity. In other words, when this description says that a particular logical module performs a particular activity, a reader may interpret such a statement to mean that the instructions configure electronic computing device 100 such that electronic computing device 100 performs the particular activity.

One of ordinary skill in the art will recognize that additional components, peripheral devices, communications interconnections and similar additional functionality may also be included within the electronic computing device 100 without departing from the spirit and scope of the present disclosure.

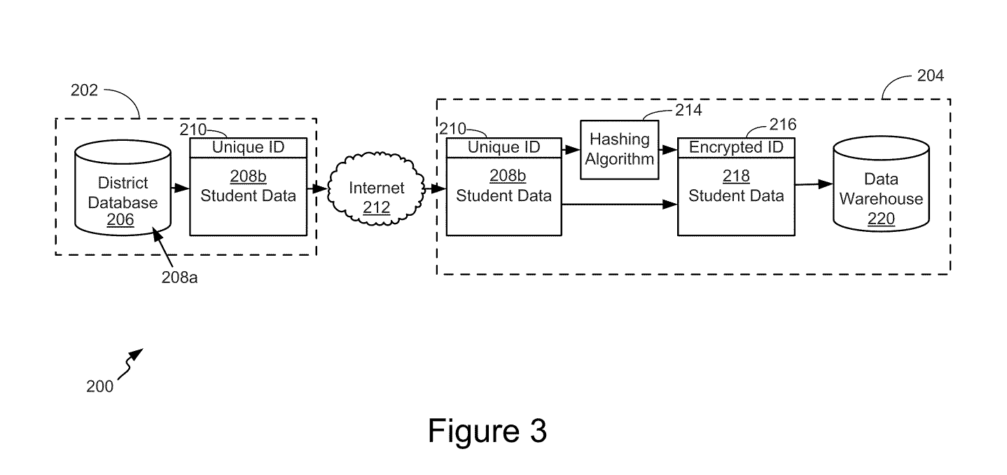

FIG. 3 illustrates a logical data flow 200 for collection and longitudinal analysis of anonymous student data, according to a possible embodiment of the present disclosure. The logical data flow 200 illustrates migration of student data records from a school district or other educational institution (illustrated as school district 202) to a student data aggregation site 204 for reporting and analysis. In the various embodiments of the present disclosure, school district 202 can be any of the school districts 102a-n of FIG. 1, and student data aggregation site can include the records server 18 and database 20.

At the school district 202, a district database 206 stores student records 208a for students enrolled at an institution affiliated with the school district. The student records 208a stored in the district database 206 are typically complete records, including personal identification associated with each student, as well as information regarding that student's actions, activities, and performance while enrolled at a school within the school district. The district database 206 can be hosted on one or more computing systems, and is generally stored in a manner that it is accessible within the school district 202, but not from external to the school district.

Each student record 208a among those records desired to be exported from the school district (or synchronized between the school district and an external system or storage) is extracted from the district database 206 and at least partially preliminarily redacted forming redacted records 208b. The redacted records 208b have sufficient information removed to be allowed to be exported from the school district. Although the specific redaction actions performed on the redacted records 208b to be exported may vary, typically those items which are uniquely identifiable to a specific student are removed. Example information can include name, address, and social security number information. In some circumstances, other information can be included as well (e.g., demographic or ethnicity information in instances where few students of a given demographic or ethnicity are enrolled at a school).

To track a record as unique once the personal identifying information is removed, typically a school district (or an external entity) will associate a unique identifier 210 with each redacted record 208b (and optionally with records 208a stored in the database 206). The unique identifier 210 can take any of a number of forms; in one possible embodiment, the unique identifier is a globally unique identifier (GUID), a randomly generated mathematically unique identifier, typically having 16 bits in length.

The redacted records 208b, or changed portions thereof, are exposed externally to the school district 202, i.e., to the student data aggregation site 204 via the Internet 212. This can occur by any of a number of methods, such as a bulk data delivery, nightly update of new records or record updates in approximately realtime.

Within the student data aggregation site 204, the redacted records 208b are processed by transmitting the unique identifier 210 associated with each record 208b through an encryption algorithm, illustrated as hashing algorithm 214. The hashing algorithm 214 can take any of a number of forms, but in the various embodiments illustrated, the hashing algorithm can be any type of one-way encryption capable of generating an encrypted identifier 216 to be associated with an anonymized record 218. The record is “anonymized” due to the fact that no school district can recognize the record as coming from that or a different district, due to the replacement of the unique identifier 210 with the encrypted identifier 216. The anonymized record 218 is stored in a data warehouse 220 at the student data aggregation site 204, for use in research and generation of reports.

Referring to FIG. 3 generally, the data flow 200 can be performed periodically, and can be configured such that only new student records or changes to student records are extracted from the school district 202 for inclusion in the data warehouse 220. In various embodiments, the data flow 200 is instantiated from the student data aggregation site 204 on a nightly, weekly, or monthly basis. In alternative embodiments, the data flow 200 is perpetual and updates are processed in near-realtime. Other embodiments and time periods for updating are possible as well.

Additionally, although the data flow 200 is illustrated using a single school district 202 and student data aggregation site 204, typically aggregation will occur among a plurality of school districts 202 associated with a single student data aggregation site 204.

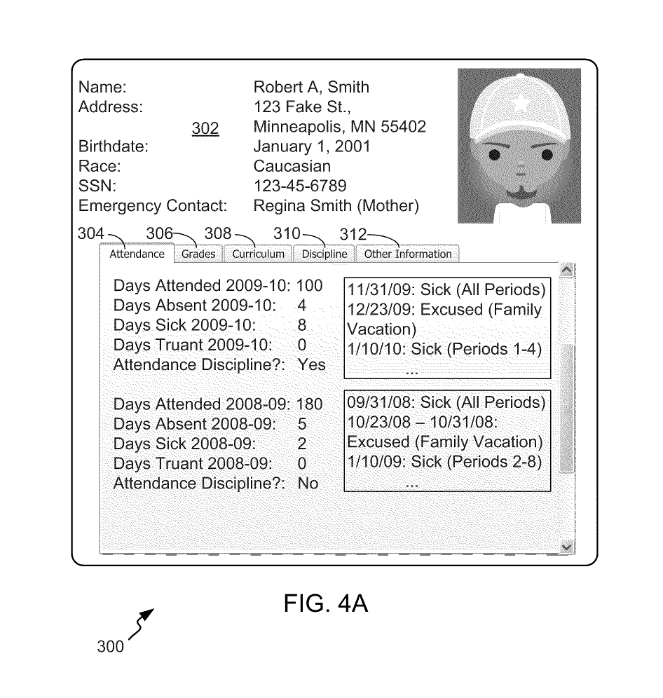

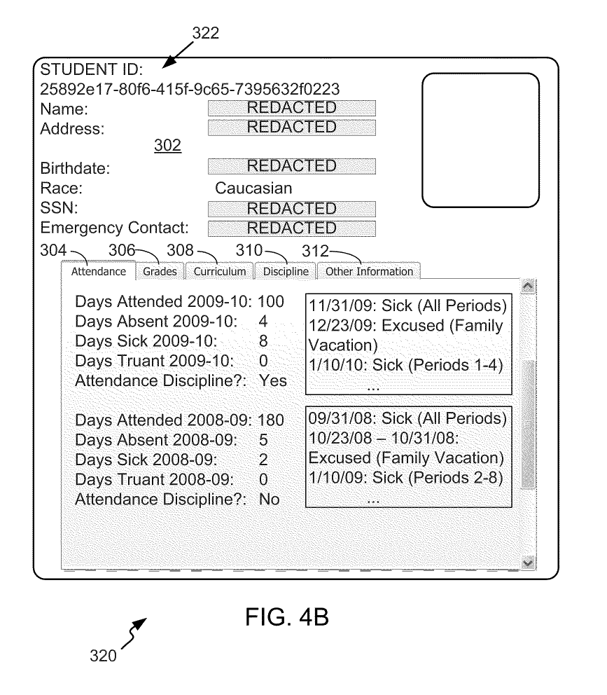

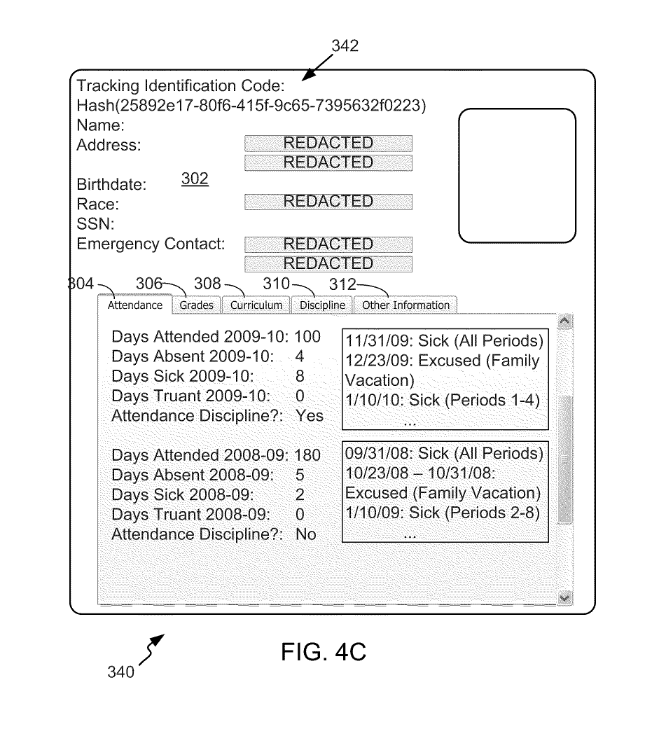

Referring now to FIGS. 4A-4C, example student data records are illustrated showing the transformation of a data record during the data flow of FIG. 3. FIG. 4A illustrates an example student record 300 held at a school district, including various types of data tracked by that school district relating to a student. In the embodiment shown, the student record 300 includes personally-identifying information 302, including, for example, name, address, birth date, race, social security number, and emergency contact information. Other types of information (e.g., other contact information such as phone or e-mail address information) for the student or various relatives of the student can be included as well.

The student record 300 also can include a number of other types of information, including attendance information 304, grade information 306, curriculum information 308, discipline information 310, and other information 312. In the embodiment shown, each of these types of information is stored in separate organized tabs; however, the particular organization of information within a student record is irrelevant for purposes of the present disclosure. Rather, the organization must merely be understandable to a data warehouse.

In the embodiment shown, specific portions of the student record 300 illustrating detailed attendance records (e.g., days absent, days attended, types of absences, etc.) are illustrated. Each of the other types of information previously described can also have a number of sub-portions within the record 300. For example, the grade information 306 could include final grades for each class in which a student has been enrolled in the past, and could also include any of a number of more detailed records such as test scores, grading corrections, extra credit assignments or projects, or other information. The curriculum information 308 can include a listing of the subjects studied by the student (either currently or historically for that student), as well as details of that curriculum, such as textbooks or other materials used, lesson plans, or other information. The discipline information 310 can include a discipline record, including types of discipline, frequency, and notes related to the discipline. The other information 312 can include any other information gathered about the student, such as library records (e.g., books checked out, fines, etc.), awards granted, behavioral notes, learning disabilities, or other information relevant to that student's education. Other information can be included in a student record as well.

FIG. 4B illustrates a student record 320 that represents a modification of the record 300 of FIG. 4A to allow its release external to the school district. For example, student record 320 can correspond to the record of FIG. 3 after it is extracted from the district database 206.

In the embodiment shown, the student record 320 includes the various fields 302-312 described above. However, the student record 320 includes an identifier 322 associated with the record that can uniquely identify the record when other information identifying the record (e.g., the student's name, social security number, etc.) is removed from the record. In the embodiment shown, the identifier 322 is a unique identifier, such as a globally-unique identifier (GUID) or other type of statistically unique identifier associated with the student. Within a school district, the identifier 322 is retained for that student, and is used to associate records with a single student. In various embodiments, a student may be associated with one or more identifiers 322; however, each identifier will typically only be associated with one student.

Additionally, when comparing student record 320 to record 300, a number of portions of the record are redacted to prevent identification of the individual student once the record is released to entities external to the school district. In the embodiment shown, a number of portions of the personally-identifying information 302 are redacted, including name, address, birthdate, social security number, and contact information. Optionally, any photographs of the student (illustrated in FIG. 4A-4B as part of the personally-identifying information 302) can be redacted as well. In the example shown, the identified race is not redacted, but could be redacted if it is individually identifying (e.g., where only a single student of a given race is enrolled within the school district.

It is noted that, in certain embodiments, the identifier 322 can be associated with a non-redacted record as well, such as record 208a stored in the district database 206. In such embodiments, the identifier 322 will remain in place (i.e. unredacted) during the redaction process, to allow encryption of that identifier upon receipt by the student data aggregation site.

FIG. 4C illustrates an example student record 340 that corresponds to the record 320 of FIG. 4B after further anonymization, according to a possible embodiment of the present disclosure. For example, the student record 340 can represent the anonymized record 218 of FIG. 3. In the embodiment shown, the record 340 includes a tracking identification code 342, which corresponds to a one-way encrypted version of identifier 322. The particular one-way encryption technique can vary in differing embodiments of the present disclosure; in certain embodiments, the technique can correspond to a hash algorithm that renders the tracking identification code 342 in a consistent manner from the identifier 322 (such that the identifier 322, when processed, results in the tracking identification code 342 each time it is hashed).

Although complete records are illustrated in FIGS. 4A-4C, often the identifier 322 and the tracking identification code 342 will be associated with partial records, as partial student records are passed between a school district and a central student information warehouse as illustrated in FIGS. 1 and 3. For example, the partial record could include the various types of information disclosed above in connection with FIG. 4A, but only with respect to a particular period of time since the last differential update of student records from the school district. Using the tracking identification code 342 (as converted by one-way encryption from district-assigned identifier 322), the various partial records can be linked and aggregated, so that a full collection of records relating to a student can be aggregated and viewed.

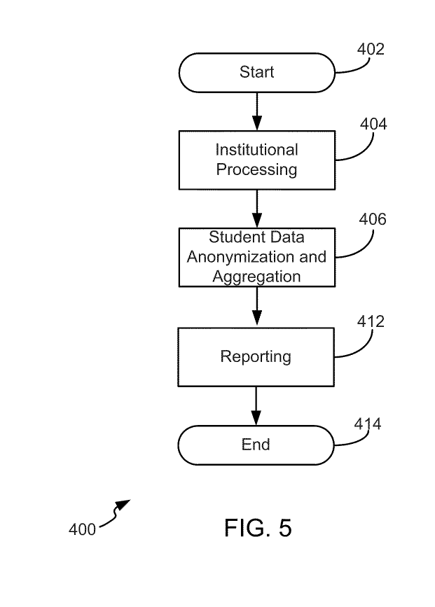

Now referring to FIGS. 5-7 flowcharts of methods and systems for collection and longitudinal analysis of anonymous student data are described according to various embodiments of the present disclosure. The methods and systems described herein can, in various embodiments, be performed using the systems, records, and data flows described above in connection with FIGS. 1-3 and 4A-4C. The methods and systems can be used in association with a number of different school districts to anonymously aggregate student data records, allowing those school districts and other entities to study trends and curriculum details within and external to a school district.

FIG. 5 illustrates methods and systems 400 for overall collection and longitudinal analysis of anonymous student data. The system 400 is instantiated at a start operation 402, which corresponds to initiation of a record update from a school district's collection of student records (e.g., records 208a in database 206 of FIG. 3). The initiation of the record update can occur at any particular time (e.g., weekly, monthly, annually, or some other period) and can either be triggered automatically or manually initiated.

An institutional processing module 404 corresponds to processing of a set of student records (or differential changes to student records) at a school district or other educational institution to prepare to export changes to the student records. The institutional processing module 404 represents a number of steps performed at the institution, such as extracting student records from a database, determining whether those records have been updated since the last extraction, and redacting information from the student records.

In a possible embodiment, the institutional processing module 404 processes the records as illustrated in the portion of the data flow illustrated within the school district 202 of FIG. 3. The redaction process can, in such embodiments, redact certain identifying information from a student record or partial student record, for example transforming a record 208a to a record 208b as in the examples of FIGS. 4A-4B above. Other data flow arrangements and systems could be used as well.

Following operation of the institutional processing module 404, the data is made anonymous to all parties except the school district that possesses the student record and the central student data warehouse (e.g. at the student data aggregation site 204). At that point, the student record could be released, but should be made anonymous to those entities as well.

An anonymization module 406 performs the anonymization process that effectively “disconnects” the student record from the school district from which it was received. The anonymization module 406 receives records processed for export from a school district or educational institution and anonymizes and stores those records in an aggregated data warehouse. In various embodiments, the anonymization module 406 extracts an identifier from a student record (which is how the student record is tracked after the preliminary redaction performed by the institutional processing module 404) and creates an anonymized student record by replacing the identifier with an encrypted identifier. In various embodiments, the encrypted identifier represents a one-way encryption (e.g., a hashed value) based on the identifier.

In a possible embodiment, the anonymization module 406 processes the records as illustrated in the portion of the data flow illustrated within the student data aggregation site 204 of FIG. 3. The anonymization module 406 can, in such embodiments, convert a student record or partial record, for example transforming a record 208b to a record 218 as in the examples of FIGS. 4B-4C above. Other data flow arrangements and systems could be used as well.

The anonymization module 406 stores the anonymized record in a data warehouse (e.g. data warehouse 220 of FIG. 3) such that it is linked with other anonymized records relating to the same student (as identified by matching encrypted identifiers). By linking all of the records by encrypted identifier, all of the student's data can be accessed together, providing a view of the entire history of that student's academic performance (e.g., via the reporting module 408, below). Optionally, and in the case where school districts store student records in varying formats, the anonymization module 406 also reconfigures the student record to place it in a format for consistent storage within a data warehouse.

Through use of the anonymization module 406, an encrypted identifier replaces the identifier associated with the student record. No correlation is stored by the student data aggregation site mapping the encrypted identifier with the identifier (other than the hash value to use). In this way, a student data aggregation site only retains knowledge of the encrypted identifier and associated redacted student record, and is unable to reverse-encrypt the encrypted identifier to determine which student relates to that student record.

A reporting module 408 allows users to access the stored, anonymized data at a data warehouse (e.g., data warehouse 220 at student data aggregation site 204 of FIG. 3). A variety of reports can be generated to detect trends in curriculums and student outcomes, disciplinary or attendance trends, or other statistical studies. The reporting module 408 can operate independently of the institutional processing module 404 and anonymization module 406, meaning that while the institutional processing and anonymization of certain sets of records or partial records is performed, a user could independently access other student record data in the data warehouse for analysis and generating reports.

Operational flow terminates at an end operation 410, which corresponds to completion of the systems and methods for anonymization of student records for reporting and analysis.

The system 400 can be operated or accessed by any of a number of individuals, who may have varying access rights depending upon the particular features or access point along a data flow of a student record. For example an employee of a school district may have access to student records before those records are anonymized by the anonymization module 406, while external individuals who are unaffiliated with the school district may not have access to those student records. However, all users may have access to student records located in the data warehouse after anonymization, on a free or subscription fee basis. Additionally, designated individuals could be tasked with instantiating student record extraction and migration from school districts to a centralized student data warehouse. Although in certain embodiments individuals at a school district would control institutional processing and individuals affiliated with an aggregation site would control anonymization, other arrangements could occur as well (e.g., where the individuals affiliated with the aggregation site control all aspects of the data flow 200 and system 400).

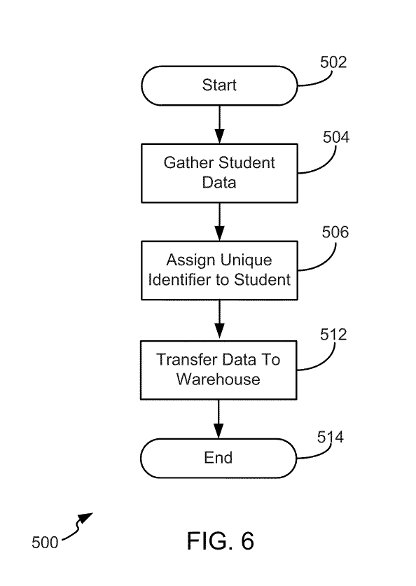

FIG. 6 is a flowchart of methods and systems 500 for exporting student data from an educational institution or entity, according to a possible embodiment of the present disclosure. The methods and system 500 can be used, for example, to accomplish the tasks of the institutional processing module 404 of FIG. 5.

The system is instantiated at a start operation 502, which corresponds generally to the start operation 402 of FIG. 5. A student data gathering module 504 corresponds to collection of student data to be exported from a school district to a centralized student warehouse. In certain embodiments, the student data is only the data that has changed since the last aggregation and export process occurred.

An identifier assignment module 506 assigns an identifier to a student record, such that each student is associated with a unique identifier. In various embodiments, the identifier can take a number of forms, such as a GUID or other randomly-generated unique number. The identifier provides a method by which the local school district or educational institution can link student records or differential updates to student records to each other, allowing formation of a complete history of a student by aggregating the portions of student records as they are received by the school district.

A transfer module 508 transfers the records (or partial records) that have been redacted to a system remote from the school district or educational institution. In some embodiments, the transfer module 508 manages a direct transfer of redacted student records to a data storage center, such as student data aggregation site 204. In other embodiments, the transfer module 508 transmits redacted data records to a separate remote site for processing prior to storage at a data storage center.

Operational flow terminates at an end operation 510, which completes the exporting of student data from the educational institution, allowing for processing and anonymization of the redacted student records by a central student record aggregator, such as student data aggregation site 204 of FIG. 3.

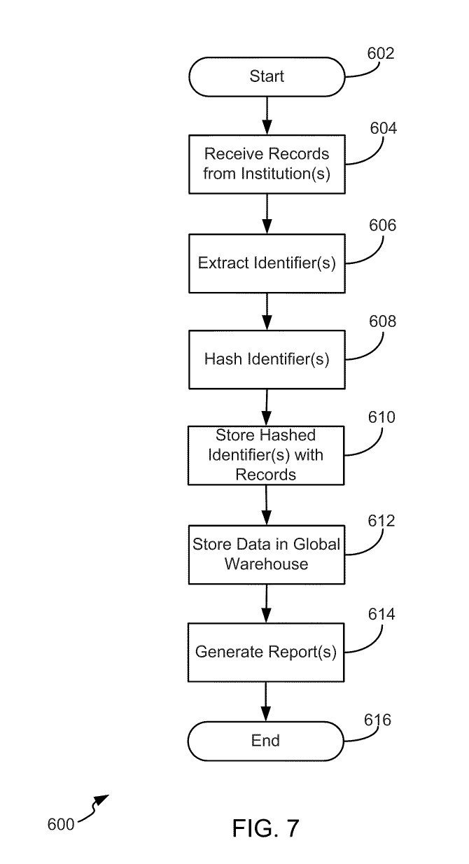

FIG. 7 is a flowchart of methods and systems 600 for extracting student data from an educational institution or entity, according to a possible embodiment of the present disclosure. The methods and system 600 can be used, for example, to accomplish the tasks of the anonymization module 406 of FIG. 5. The methods and systems can be performed, in various embodiments, by a central student record aggregator, such as student data aggregation site 204 of FIG. 3.

A start operation 602 initiates the methods and systems illustrated, and can occur, for example, upon receipt of student records transmitted to the central student record aggregator. A receive records module 604 receives the records at a central student record aggregator. The received records are generally redacted records that include a unique identifier associated with a particular student (e.g., records 208b of FIG. 3). In certain embodiments, the receive records module 604 converts the records to a format consistent with other records stored at a student data aggregation site. For example, the receive records module 604 can include various business logic or data transformation systems capable of processing student records received in differing formats from each of the various school districts or institutions from which records are received.

An identifier extraction module 606 extracts the identifier (i.e. the identifier applied via the identifier assignment module 506) associated with each student record. An identifier encryption module 608 applies an encryption algorithm to the extracted identifier, preferably using a one-way encryption method (e.g., a hashing algorithm as described above). An identifier storage module 610 stores the hashed identifier in association with the same student record. By use of modules 606-610, the received records are anonymized by removing all information known by an entity that would link a student with a record. As described above in FIGS. 5-6, records are redacted at a school district to prevent external individuals from identifying the student associated with the record. By anonymizing the identifier, the student record is also rendered anonymous to the school district at which the student is enrolled, because the school district lacks knowledge of the hash algorithm used at the central student record aggregator.

A data storage module 612 stores the student records in a data warehouse for storage and access by systems both within the school district and individuals external to the school district, as explained above with respect to FIG. 1. A report generation module 614 allows those individuals or districts to generate reports of varying types based on the information held in the data warehouse. An end operation terminates operation of the methods and systems 600.

Referring now to FIGS. 5-7 generally, it is noted that the methods and systems 600 can be performed with respect to student records received from a large number of school districts or educational institutions. Therefore, it is noted that although the systems and methods 500 of FIG. 6 may be performed by different entities, the methods and systems 600 of FIG. 7 are typically performed at a centralized location to allow for consistent data management. Consistent with the present disclosure, certain tasks (e.g., data transformation or formatting) can optionally be performed as part of the systems and methods used at the various locations prior to transfer of student records.

By anonymizing student data records using the methods and systems of the present disclosure, entities and individuals external to a school district can analyze student data to detect trends across a number of different school districts, or to detect trends in a student's education along the entire length of that student's educational career, while removing sufficient information that confidentiality concerns can be addressed. Additionally anonymizing student data records allows third party management of data records for student records, providing increased efficiency and data management consolidation. Other advantages are provided as well.

The above specification, examples and data provide a complete description of the manufacture and use of the composition of the invention. Since many embodiments of the invention can be made without departing from the spirit and scope of the invention, the invention resides in the claims hereinafter appended.

1. A method for aggregating and anonymizing student data comprising:
receiving from an educational institution a set of student data records, each student data record associated with a student and including a unique identifier, and lacking information rendering the record personally identifying of a student; and
for each student data record:
extracting the unique identifier associated with the student data record;
encrypting the unique identifier;
associating the encrypted unique identifier with the student data record to form an anonymized student data record; and
storing the anonymized student data record in a database containing aggregated student data.

2. The method of claim 1, further comprising generating a report based on the aggregated student data in the database.

3. The method of claim 1, wherein encrypting the unique identifier comprises applying a hash algorithm to the unique identifier.

4. The method of claim 1, wherein each of the student data records is redacted to remove student data selected from the group consisting of:
name information;
address information; and
demographic information.

5. The method of claim 1, wherein associating the encrypted unique identifier with the student data record comprises replacing the unique identifier with the encrypted unique identifier.

6. The method of claim 1, wherein each student data record includes a plurality of types of information selected from the group consisting of:
attendance information;
grade information;
disciplinary information;
demographic information; and
curriculum information.

7. A system for aggregating and anonymizing student data, the system comprising:
a database configured and arranged to store aggregated student data;
a computing system external to educational institutions and communicatively connected to the database, the computing system configured to receive a set of student data records from each of a plurality of educational institutions, each student data record associated with a student and including a unique identifier, and lacking information rendering the record personally identifying of a student, the computing system configured to process each student data record in each set of student data records, wherein the computing system is configured to, for each student data record:
extract the unique identifier associated with the student data record;
encrypt the unique identifier;
associate the encrypted unique identifier with the student data record to form an anonymized student data record; and
store the anonymized student data record in the database.

8. The system of claim 7, wherein the computing system is configured to periodically receive a set of student data records from each of the plurality of educational institutions.

9. The system of claim 7, wherein the computing system is configured to request receipt of the set of student records from each of the plurality of educational institutions.

10. The system of claim 7, wherein each student data record includes a plurality of types of information selected from the group consisting of:
attendance information;
grade information;
disciplinary information;
demographic information; and
curriculum information.

11. The system of claim 7, wherein each of the student data records is redacted to remove student data selected from the group consisting of:
name information;
address information; and
demographic information.

12. The system of claim 11, wherein each of the student data records is redacted prior to receipt by the computing system.

13. The system of claim 7, wherein encrypting the unique identifier comprises applying a hash algorithm to the unique identifier.

14. The system of claim 7, wherein the computing system is further configured to generate a report based on the aggregated student data in the database.

15. A system for aggregating and anonymizing student data, the system comprising:
a plurality of computing systems residing at a corresponding plurality of educational institutions and configured to manage student data for the corresponding educational institutions;
a central database configured and arranged to store aggregated student data;
a central computing system external to educational institutions and communicatively connected to the central database and to each of the plurality of computing systems, the central computing system configured to receive a set of student data records from each of the plurality of computing systems, each student data record associated with a student and including a unique identifier, and lacking information rendering the record personally identifying of a student, the central computing system configured to process each student data record in each set of student data records, wherein the central computing system is configured to, for each student data record:
extract the unique identifier associated with the student data record;
apply a hash algorithm to the unique identifier;
associate the hashed unique identifier with the student data record to form an anonymized student data record; and
store the anonymized student data record in the central database.

16. The system of claim 15, wherein the central computing system is further configured to generate a report based on the aggregated student data in the central database.

17. The system of claim 15, wherein each of the plurality of computing systems is configured to redact the student data records prior to receipt of the student data records by the central computing system.

18. The system of claim 17, wherein each of the plurality of computing systems is configured to redact student data selected from the group consisting of:
name information;
address information; and
demographic information.

19. The system of claim 15, wherein each student data record includes a plurality of types of information selected from the group consisting of:
attendance information;
grade information;
disciplinary information;
demographic information; and
curriculum information.

20. The system of claim 15, wherein each of the plurality of computing systems is configured to periodically transmit a set of student data records to the central computing system.
